(19) United States
(12) Patent Application Publication
(10) Pub. No.: US 2023/0256610 A1
(43) Pub. Date: Aug. 17, 2023

(54) COMPONENT MANAGEMENT SYSTEM AND METHOD

(71) Applicant: Tangram Robotics, Inc., Burlingame, CA (US)

(72) Inventors: Jeremy Steward, Burlingame, CA (US); Brandon Minor, Burlingame, CA (US)

(21) Appl. No.: 18/102,174

(22) Filed: Jan. 27, 2023

Related U.S. Application Data
(60) Provisional application No. 63/303,663, filed on Jan. 27, 2022.

(51) Int. Cl. B25J 9/16

(52) U.S. Cl. CPC B25J 9/1692; B25J 9/161; B25J 9/163

(57) ABSTRACT

In variants, the method can include: providing a set of component streams, generated by set of components of the robot, to a host system of the robot; determining a component state change; and determining an updated calibration responsive to the component state change, based on the component streams and a set of calibration equations compiled based on the calibration representations for each of the set of components.

### CROSS-REFERENCE TO RELATED APPLICATIONS

This application claims the benefit of US Provisional Application number 63/303,663 filed 27-JAN-2022, which is incorporated in its entirety by this reference.

### TECHNICAL FIELD

This invention relates generally to the component management field, and more specifically to a new and useful asynchronous system in the component management field.

### BRIEF DESCRIPTION OF THE FIGURES

FIG. 1 is a schematic representation of a variant of an asynchronous component management system.

FIG. 2 is a schematic representation of an example of data transferred between components of a variant of the component management system.

FIG. 3 is a schematic representation of a second example of data transferred between components of a second variant of the component management system.

FIG. 4 is a schematic representation of a variant of the routing module.

FIG. 5 is a schematic representation of a variant of observation stream merging.

FIG. 6 is a schematic representation of a second variant of observation stream merging.

FIG. 7 is a schematic representation of a variant of component calibration representation merging.

FIG. 8 is an illustrative example of component addition during system operation.

FIG. 9 is a schematic representation of a variant of the method.

FIG. 10 is an illustrative example of a robot calibration representation.

FIG. 11 is an illustrative example of a component calibration representation.

FIG. 12 is an illustrative example of compiling the equations for a component set and determining the calibration.

FIG. 13 is a schematic representation of a variant of the method.

FIG. 14 is a schematic representation of a second variant of the method.

### DETAILED DESCRIPTION

The following description of the embodiments of the invention is not intended to limit the invention to these embodiments, but rather to enable any person skilled in the art to make and use this invention.

### 1 Overview

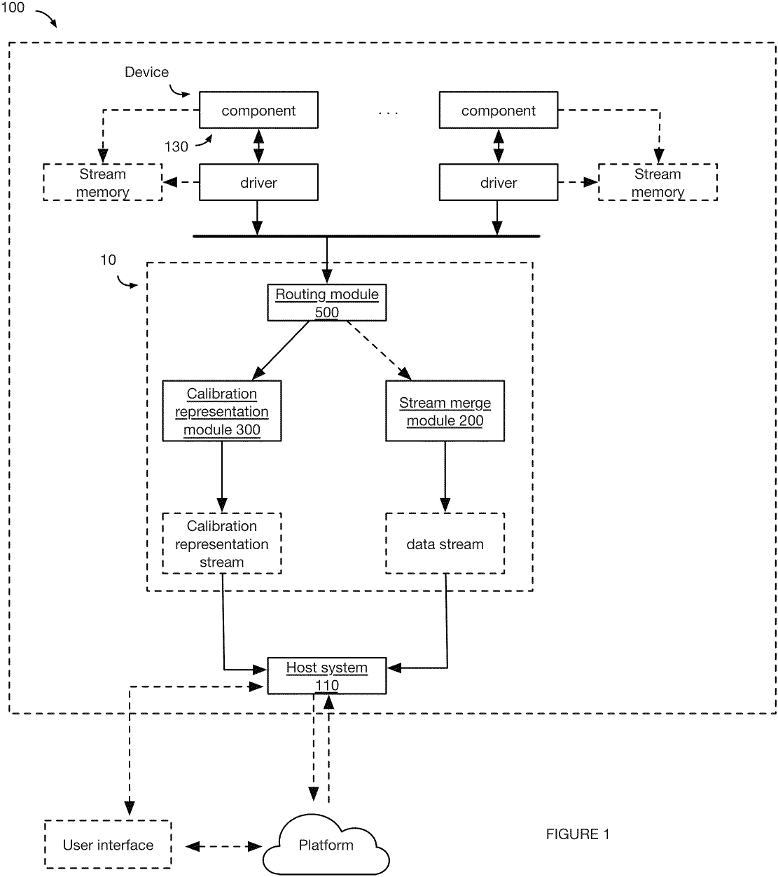

As shown in FIG. 1, in variants, the component management system can include: a routing module; a calibration representation module; a stream merge module; and a calibration module. The system functions to enable dynamic component connection and/or disconnection to a robot’s host system (e.g., enable plug-and-play functionalities) without disrupting host system operation. The system can also provide an asynchronous, concurrent, unified integration layer to stream sensor measurements from multiple sensors of different modalities that are manufactured by different entities (e.g., OEMs) to endpoints (e.g., host systems).

In an illustrative example, the component management system for a robot 100 (e.g., including a host system 110 and a set of components 130) can include: a stream merge module 200 configured to poll observation streams 210 generated by each of a set of sensors (e.g., components 130), generate a unified observation stream, and provide the unified observation stream to a host system 110; a calibration representation module 300 configured to identify new component configurations (e.g., new sets of components connected to the host system, new physical component arrangements, etc.) and determine a set of calibration representations 310 for each new component configuration; and a calibration module 400 configured to determine new calibrations 410 for the robot based on the set of calibration representations and the observations (e.g., from the unified observation stream). In variants, the component management system can also include a routing module 500 that functions to route driver messages to the modules and/or to a user interface (e.g., route stream events to the stream merge module, route calibration representation events to the calibration representation module, route user events to the user interface, etc.).

In illustrative examples, the method can include: providing a component stream, generated by a component of the robot, to a host system of the robot S100; determining a component state change S200; and determining an updated calibration S300 responsive to the component state change, wherein the updated calibration can be determined by: determining a calibration representation for the robot (e.g., by determining a calibration representation for each component within the robot, for each component connected to the host system, for each component generating an observation stream, or for each component that provided a component calibration representation, etc.); determining a set of calibration equations based on the calibration representation; and determining (e.g., calculating) the updated calibration using the set of calibration equations and the observations, wherein the host system can use the updated calibration to process (e.g., correct) subsequent component observations. In variants, determining the set of calibration equations can include: identifying which intrinsic submodel for each intrinsic parameter is specified in the component calibration representation for a given component; retrieving the calibration equations for each identified intrinsic submodel; determining a set of extrinsic calibration equations based on a set of constraints specified in the calibration representation; and compiling the retrieved and determined calibration equations together into the calibration equation set.

### 2. Technical Advantages

Variants of the technology can confer several technical advantages over conventional systems.

First, variants of the technology can prevent events from a single device, such as component addition, removal, or disconnection, from interfering with overall system operation. For example, variants of the technology can prevent device events from interfering with individual tasks or operations outside of the device’s scope during system operation. In variants, this is accomplished by modularizing the representation of each component, enabling modular system configuration, and/or using processing modules that only include asynchronous, non-blocking, and/or atomic individual tasks, such that the tasks can execute entirely independently of each other (e.g., are not dependent upon completion of another task). This enables overall asynchronous system operation in a non-blocking manner. For example, this enables the system to continually stream observations, even when an individual device (e.g., component, sensor, etc.) experiences an adverse event. In contrast, conventional component management systems are event-based and pause to await prior task completion before continuing with the next task; this can result in gaps in the observation stream, gaps in component measurement interpretation (e.g., because the system is uncalibrated), and/or other adverse effects when an adverse event occurs.

Second, variants of the technology can reduce computing resource constraints, which can enable horizontal and vertical computing resource scaling. For example, by using asynchronous, non-blocking tasks, this system does not require a minimum number of processing threads, and/or does not require explicit pre-allocation of processing unit cycles. This means that the system can dynamically scale computing resource consumption up or down, based on demand. Variants of the technology can also reduce computing memory usage (which can be limited in onboard systems) by passing memory identifiers (e.g., pointers, polymorphic pointers) between modules instead of values (e.g., observation values). This can prevent value and/or pointer duplication (e.g., enable zero- or minimal copy), thereby reducing the amount of onboard memory used.

Third, variants of the technology can create a plug-and-play system, where sensors can be connected to a robot and immediately work without prior knowledge or reliance on sensor-specific data formats or proprietary interfaces. In variants, this can be enabled by abstracting away component-specific drivers and driver APIs by using a unified interface (e.g., a single unified API and set of endpoints) that the components, host systems, and/or robot programmers adhere to (e.g., sensor streaming is not implemented for each component’s SDK/API or streaming methodology). In examples, the conversion between the driver API and the unified API can be enabled by a set of platform translation modules. In other variants, this can be enabled by pushing sensor stream interpretation to the host system, such that the host system can receive the sensor stream without additional configuration, but may require component-specific libraries to be installed and locally executed to interpret said stream.

Fourth, variants of the technology can reduce observation streaming latency, since the observation serving task is not blocked by other tasks, even when an adverse event occurs. In other variants, this can be enabled by incorporating the components at as low a level as possible (e.g., as close as possible to the raw measurement format, as close to machine code as possible, etc.), since no modality-specific semantics are required when polling for data during unified stream compilation. For example, accelerometer events can be delivered in the same manner (e.g., using the same system, the same serialization format, the same message transport protocol, etc.) as image events.

Fifth, variants of the technology can be communication paradigm agnostic, and can work with any serialization paradigm, any serialization format, any message transport paradigm, and/or any message transport protocol by modularizing the processes (e.g., serialization and message transport are not vertically integrated or mutually dependent).

However, further advantages can be provided by the system and method disclosed herein.

### 3 System

In variants, as shown in FIG. 1, the component management system 10 can include: a routing module 500; a calibration representation module 300; a stream merge module 200; and a calibration module 400.

The component management system 10 can be used with a set of robots 100. Each robot preferably executes an instance of the system 10, but can alternatively execute multiple instances of the system. Examples of robots include: vehicles (e.g., aerial vehicles, terrestrial vehicles, aquatic vehicles, autonomous vehicles, semi-autonomous vehicles, advanced driver assist systems (ADAS), etc.), industrial machines, pick-and-place machines, security systems, and/or any other suitable system with a set of sensors and a processing system.

Each robot 100 can include one or more host systems 110 and a set of components 130, which can optionally be organized into a set of devices. The set of components 130 can be connected to the host system 110, to one or more of the other devices, and/or connected to other endpoints. The connections can be direct connections or indirect connections. The connections can be wired or wireless. Examples of wired connections that can be used include USB (e.g., USB-A, USB-C, microUSB, etc.), Ethernet, MIPI, CAT, OBD, lightning, thunderbolt, and/or other wired connections. Examples of wireless connections that can be used include: Bluetooth (e.g., BLE, Bluetooth classic), UWB, WiFi, NFC, Zigbee, and/or other wireless connections.

The host system 110 functions to receive and process observation streams 210, driver messages, and/or other device information from one or more devices. For example, the host system can adjust and/or interpret observations based on the calibration set. In variants, the host system can also: execute the component management system, provide a user interface to the set of devices, store the calibration representations (e.g., calibration specifications), determine the calibration representations, store the calibration set, calculate the calibration set, coordinate with a calibration module to determine the calibration set, correct observations using the calibration set, process the observations (e.g., run SLAM, dead reckoning, object detection, and/or other processes using the corrected observations), interact with the observations or driver messages using the driver API, and/or perform other functionalities. Each robot can include one or more host systems. The host system can be centralized or decentralized. The host system can be a local processing system, a remote processing system, and/or be otherwise configured.

A device (e.g., a sensor package) can include one or more components 130, and can optionally include a housing enclosing or mounting said components. Additionally or alternatively, a component can be a device, set of devices, and/or otherwise defined. Devices and components can be real (e.g., physical, tangible, etc.), virtual (e.g., simulated, synthetic, etc.), or otherwise defined.

A component 130 is preferably a data source. The component can be a physical or virtual data source. In a first example, a physical component can be a single sensor or an indivisible sensing unit (e.g., that would lose a sensing capability if subdivided further), but can be otherwise defined. In a second example, a virtual component can be a database of recorded sensor observations, an external data source (e.g., accessible via an API or other data interface), a data object, a ROSBag, and/or other virtual data source. Each component can be associated with: a component state (e.g., online, offline, connected, disconnected, changed, etc.), a component identifier (e.g., locally unique identifier, shared identifier, etc.; specified by the driver, the component management system, or other system), device information (e.g., the one or more output observation types), and/or other information (e.g., stored by a platform, stored by the component, stored by the driver, etc.). Each component can output one or more observation streams 210 (e.g., component streams, etc.), event streams, and/or other data streams. Each observation stream can include a time-series of observations (e.g., measurements) and/or other information. The component data stream emission can be controlled by the component’s driver, by the component itself, and/or otherwise controlled. Examples of components can include: optical sensor, mapping sensor, position sensor, kinematic sensor, electromagnetic sensor, vibration sensor, environmental sensor, radiation sensor, location sensor, clocks (e.g., temporal sensor), and/or any other suitable sensor.

Each component or device can be associated with a driver. A driver is preferably specific to a device (e.g., includes instructions for all components of the device), but can alternatively be specific to a component, be specific to a device instance, be specific to a component instance, support multiple devices, or be otherwise defined. Each device is preferably configured and/or controlled by one driver, but can alternatively be configured and/or controlled by multiple drivers.

The drivers are preferably provided (e.g., defined, specified, written, etc.) by the device manufacturer, but can alternatively be provided by the component manufacturer, by a third party, by the platform, by the user, and/or be otherwise created. The drivers are preferably compliant with and/or responsive to a driver-specific API (e.g., enabling an external system to interact with the device, the component, and/or the device information), wherein different drivers for different manufacturers and/or devices can have different APIs. The drivers can additionally or alternatively be compliant with a unified platform-standard API (e.g., responds to data received in the platform-standard API format, presents data in the platform-standard format, etc.) and/or any other suitable API. In variants, external systems (e.g., as fleet management systems, user devices, host systems, the platform, etc.) can interact with the drivers (e.g., via the driver API) through a system connected to the device or component (e.g., the host system; a user interface communicatively connected to the device or component, such as a web browser or smartphone application; the platform, etc.), or otherwise interact with the drivers.

The drivers can function to configure device operation, determine component state (e.g., connected, disconnected, etc.), generate device or component events, and/or perform other functionalities. Examples of configuring device operation include: starting the device, stopping the device, starting an individual component, stopping an individual component, setting dynamic device or component configurations, setting static device or component configurations (e.g., which may require resetting the component or the device), and/or otherwise interacting with the device. Examples of dynamic configurations can include: exposure time, white balance, camera focus, field of view, zoom, sampling rate, and/or other configuration parameters. Examples of static configurations can include resolution and/or other configuration parameters. Examples of device or component events that the driver can generate can include: component connection to the overall system, component disconnection from the overall system, physical pose changes, failure events (e.g., temperature too high, device lacks power, invalid settings, etc.), and/or any other device or component event.

The driver can generate driver messages, control observation generation or output, and/or otherwise respond to component event detection. The driver messages can include (e.g., depending on the message type): a component event identifier, a device identifier; device information; and/or any other information. The driver message can conform to the driver-specific API, the platform-standard API, and/or any other suitable format.

Each driver can also register itself with the routing module, reserve a memory space for the respective component’s observation values (“stream memory”), determine an observation stream identifier (e.g., associated with the memory space), and/or perform other functionalities.

Each component or device can generate component or device information. The device information can be generated by the constituent components, generated by a device processor, specified by the driver, be inferred by a downstream module, and/or be otherwise determined.

The component or device information can include: one or more observation streams 210, driver messages, and/or other data.

An observation stream 210 (e.g., component stream, component data stream, etc.) is preferably representative of one or more observations output by a component (e.g., sensor) connected to the driver. The observation stream can be: a trait or interface (e.g., Rust trait; defining a set of behaviors for one or more programmatic types; etc.); a pointer to a memory space storing the respective component’s observations (e.g., a polymorphic pointer, a type-specific pointer, etc.); a memory space storing the respective component’s observations (e.g., a set of bits, bytes, etc.); an array (e.g., storing the observations), a time series of observations, a subscription endpoint, and/or be otherwise defined. Each component is preferably associated with one observation stream, but can alternatively be associated with multiple observation streams. The observation streams output by different components (e.g., different component types, manufactured by different entities, etc.) preferably have the same observation stream trait (e.g., a polymorphic trait; the different observation streams are compliant with the same format, with the same data object, with the same library, with the same object class, etc.), but can alternatively have different traits, be different classes, and/or otherwise vary. The observations within the observation streams can vary, but can alternatively be compliant with the same format or object type. The observation stream can be identified by an observation stream identifier (e.g., specified by the driver, specified by the stream merge module, specified by the component, etc.), and/or otherwise identified. The observation stream identifier can be a pointer, a reserved name (e.g., driver identifier, component identifier, etc.), and/or other identifier. In a specific example, the observation stream identifier can be a pointer to a memory space storing an observation object having an observation type, wherein the observation type supports the observation stream trait (e.g., defines a function called by the stream trait, has a behavior associated with the stream trait). However, the observation stream, observation stream identifier, observation type, and/or observation stream can be otherwise defined. The observation stream can be associated with: an observation stream state (e.g., “new”, “none”, “changed”, etc.; determined by the driver, etc.), no additional information, and/or any other information. The observation stream can be separate from the driver messages, be a payload within a driver message, and/or be otherwise related to the driver message.

Component observations are preferably raw observations (e.g., measurements) output by the component, but can alternatively include transformed, compressed, and/or otherwise processed observations. The observations can be associated with: the component’s unique identifier, optionally the observation type (e.g., image, point cloud, etc.), metadata (e.g., observation timestamp, component parameters, etc.), the observation time, the component’s configuration values used to obtain the observation, and/or other metadata. The observation type can be associated with one or more traits (e.g., “Stream”), which can be shared with other observation types. Examples of observations include: images, point clouds, temperature measurements, pressure measurements, inertial measurements (e.g., acceleration, gyroscopic measurements, tilt, etc.), positioning measurements (e.g., GPS measurements), light measurements, acoustic measurements, proximity measurements, contact measurements, distance measurements (e.g., IR, ultrasound, laser, encoders, etc.), voltage, current, and/or other observations. The observations can be sampled, measured, inferred, computed, and/or otherwise determined.

Observation sampling (e.g., how, what, and when observations are sampled) can be configured by the driver or by another system (e.g., using the static and/or dynamic configurations). The observations for a given component are preferably stored in a memory space (e.g., a memory space allocated by the driver, by the system, etc.), and identified by an observation stream identifier (e.g., pointer), wherein other system modules can reference the memory space for the observation values. Alternatively, the observation values can be moved (e.g., copied, transferred, etc.) between modules.

Driver messages function to notify downstream modules and endpoints about component events. Driver messages are preferably generated by the driver, but can alternatively be received by the driver. Driver messages can be automatically generated upon occurrence of a predetermined set of device events (e.g., device or component detection, device or component disconnection, device or component state change, etc.), upon query receipt, and/or at any other time. The driver messages can include: a message type (e.g., device event, user message, observation stream, calibration representation, etc.), and optionally a payload. Examples of payloads can include: an observation stream, calibration information (e.g., a calibration representation for the component, device, robot, etc.), a component identifier, new component connection events (e.g., generated when the respective component is connected to the host system), component removal events (e.g., generated when the respective component is disconnected from the host system; when the component is no longer detected by the driver; etc.), user messages (e.g., uptime, sampling rate, etc.), and/or other information. In a first example, the new component message can have a new component message type, and include the observation stream (e.g., stream identifier for the component’s observation stream) and a component calibration representation for the component. In a second example, the component removal message can have a remove component message type and include an identifier for the disconnected component(s). The driver message can be compliant with a driver message protocol, a platform-standard message protocol, a message transport protocol, and/or any other suitable protocol. However, the driver messages can be otherwise configured.

The component management system 10 can also be used with a set of calibrations 410. The set of calibrations 410 can include a single calibration or multiple calibrations. The set of calibrations 410 can be for the robot (e.g., robot calibration), be for a single component (e.g., component calibration), be for a device (e.g., device calibration), be for a set of components or devices, and/or be for any other set of elements. The calibration set can include a set of calibration matrices. The set of calibration matrices can include intrinsic calibration matrices (e.g., for intrinsic component parameters), extrinsic calibration matrices (e.g., for extrinsic component parameters), temporal calibration matrices, covariances, uncertainties, and/or other information. The set of calibration matrices can include a different subset of calibration matrices for each device or component, include a single calibration matrix for the entire component set, and/or be otherwise configured. The calibration set can be associated with an identifier, a timestamp, a robot calibration representation, an identifier for the calibration representation set, a set of device identifiers, a set of component identifiers, and/or any other suitable set of metadata and/or identifier.

The calibration set 410 is preferably determined by the calibration module 400, but can be otherwise determined. The calibration set 410 can be determined before robot operation, during robot operation (e.g., without robot operation interruption, with robot operation interruption, etc.), after robot operation, and/or at any other suitable time.

The calibration set (e.g., calibration 410) can be determined responsive to a recalibration event, periodically determined, and/or determined at any other time. The recalibration event can be: determination of a device event (e.g., device state change, component state change, device connection event, device disconnection event, etc.), an observation error or uncertainty exceeding a threshold, a downstream analysis error or uncertainty exceeding a threshold, determination of a new calibration representation (e.g., a new system or component calibration representation detected in the calibration representation stream, etc.), satisfaction of a temporal condition, receipt of a recalibration request, and/or any other suitable calibration event.

The calibration set 410 is preferably determined based on observations received from the set of devices, but can alternatively be determined based on synthetic observations, be predetermined, and/or be otherwise determined. The calibration set is preferably determined based on a calibration representation or set thereof, but can alternatively be determined using a set of predetermined equations, and/or otherwise determined.

A calibration representation 310 (“Plex”, calibration specification, etc.) functions to include the information needed to calibrate one or more components. In variants, a new calibration representation can also function as an indication for recalibration.

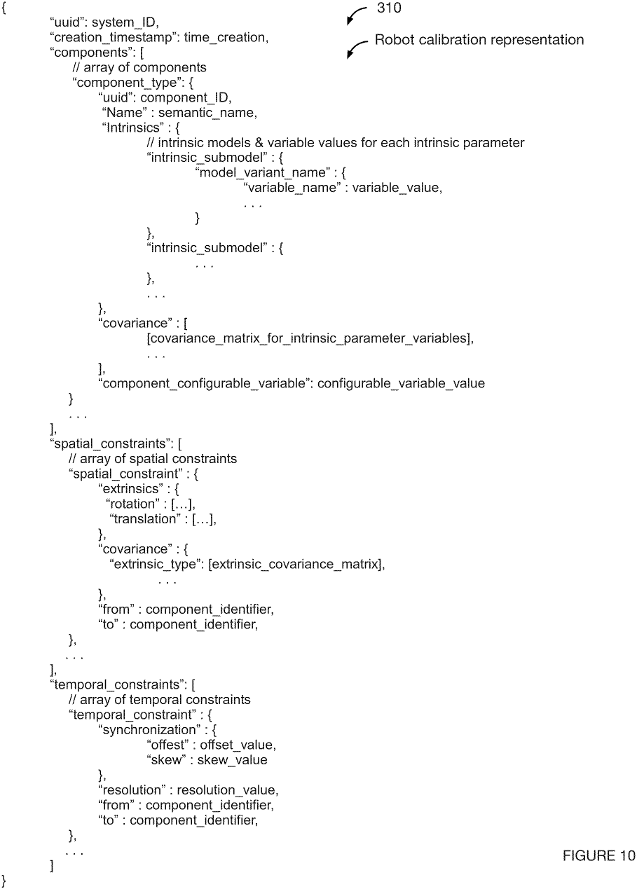

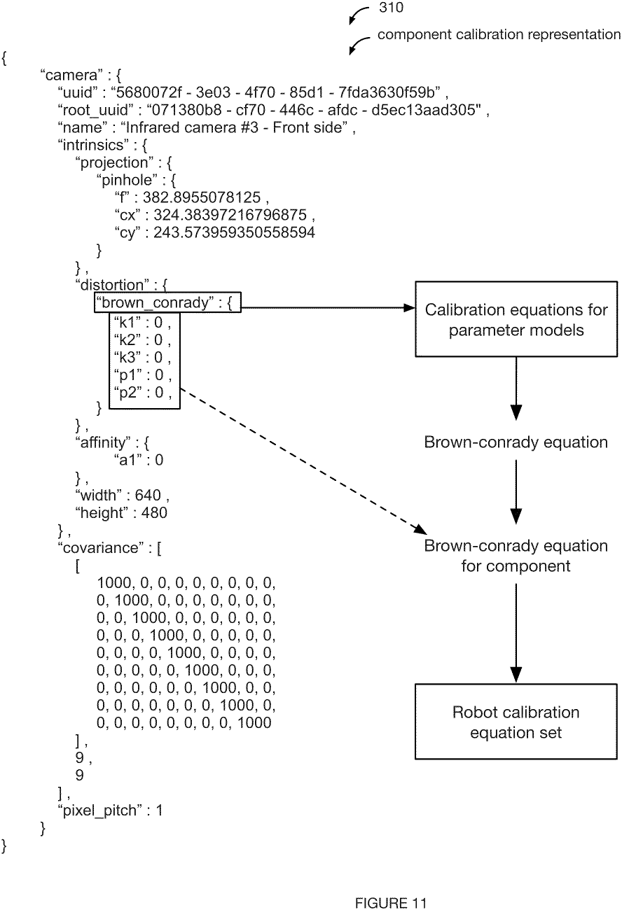

The calibration representation 310 (e.g., examples shown in FIG. 10 and FIG. 11) preferably does not include the actual calibrated parameter values (e.g., intrinsic matrix, extrinsic matrix, synchronization information, etc.), but can alternatively include the calibrated parameter values. Instead, the calibration representation preferably includes the specification needed to compile and set up the calibration equation set, which is then optimized — using the observations from the respective component(s) - to determine the calibrated parameter values. Alternatively, the calibration representation can include the calibrated parameter values (e.g., exclusively or non-exclusively), such as a set of calibration matrices.

The calibration representation 310 preferably identifies which parameter model option (e.g., transformation model, intrinsic submodel, etc.) to use for each component parameter for a given component’s type, but can alternatively include a set of observation calibration equations and/or include any other observation calibration information for a given component. Each component type is preferably associated with a different set of component parameters, which, in turn, are each associated with a different set of parameter model options. Examples of component types can include: camera, LiDAR, accelerometer, gyroscope, GPS, clocks, and/or other sensing modalities. The component parameters are preferably intrinsic parameters and/or temporal parameters (e.g., synchronization parameters), but can alternatively be extrinsic parameters. Examples of component parameters can include: distortion, projection, affinity, bias, scale, range, azimuth, horizontal, altitude, click (e.g., modeling how far a radar click is off the beam path), position, count, ionosphere, troposphere, drift, offset (e.g., epoch offset between two clocks), skew (e.g., scale offset between two clocks), and/or other parameters internal to the component itself. The parameter model option is preferably one of multiple candidate parameter model options for the component parameter, but can alternatively be the only candidate parameter model. Each parameter model (e.g., within the set of candidate parameter model options) preferably models a single intrinsic parameter, but can alternatively model multiple intrinsic parameters, or model other parameters. The parameter models (e.g., intrinsic submodels) available for each modeled parameter are preferably predefined, but can be otherwise defined. The parameter models are preferably a set of equations and variables, and identified by a unique identifier (e.g., the parameter model name), but can alternatively be other models.

For example, the calibration representation 310 can specify which parameter models to use (e.g., distortion model identifier, affinity model identifier, etc.) for one or more components. In an illustrative example, the component calibration representation for a camera can specify whether to use a Brown-Conrady or Kannala Brandt model for distortion, whether to include shear, scale, or shear and scale for affinity, and which projection model to use (e.g., pinhole, etc.). The identified parameter model option can subsequently be used to retrieve the respective calibration equation set when compiling the final set of calibration equations (e.g., calibration set equation set) to be optimized, or be otherwise used.

The calibration representation 310 can optionally include: a component identifier (e.g., identifying which component the set of parameter model options should be used to calibrate), the component type of the component (e.g., “camera”, “LiDAR”, “RADAR”, etc.; wherein the component type is associated with an parameter model), the observation types output by the component, parameter values (e.g., intrinsic parameter values, extrinsic parameter values, temporal parameter values, etc.), parameter uncertainties (e.g., variance-covariance matrix for the parameters), configurable variables (e.g., supported image formats, streaming configurations, etc.), the native coordinate frame (e.g., x/y/z directionality, left vs. right handed), constraints (e.g., component relationships, directional constraints, etc.), and/or other data.

In examples, the calibration representation 310 can be the system representations and/or the component representations described in US Application No. 17/885,135 filed 10-AUG-2022, which is incorporated herein in its entirety by this reference. However, the calibration representation can be otherwise configured.

The calibration representation 310 can be: specified by a user, specified by the manufacturer of the component or the device, specified by the driver (e.g., wherein the values are coded into the driver), specified by the platform (e.g., be default values), calculated (e.g., during calibration), dynamically determined (e.g., learned), inferred, be random values, or otherwise specified.

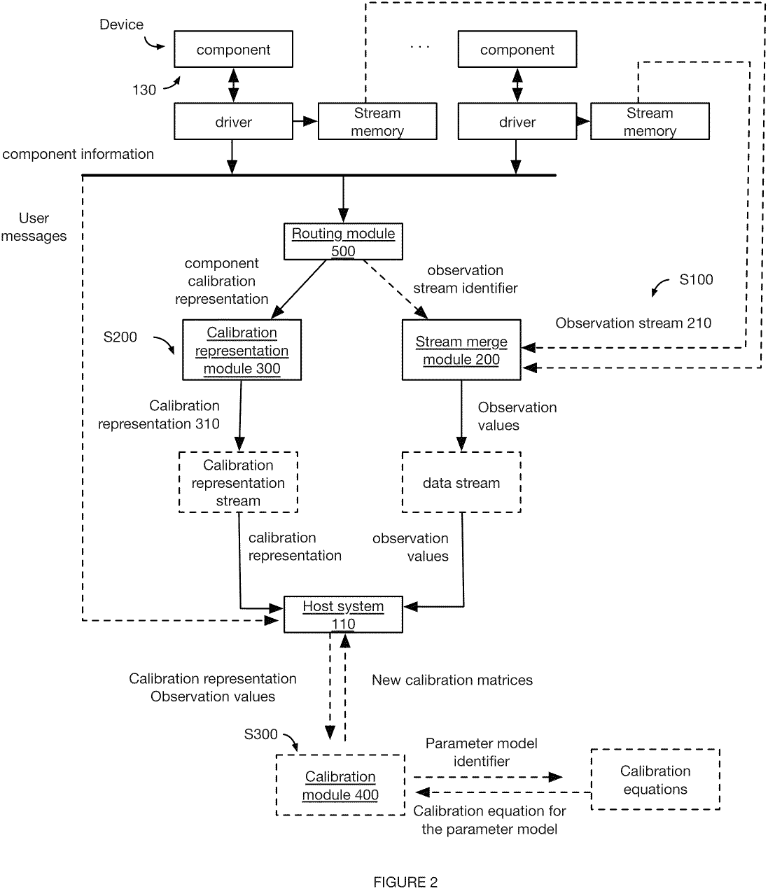

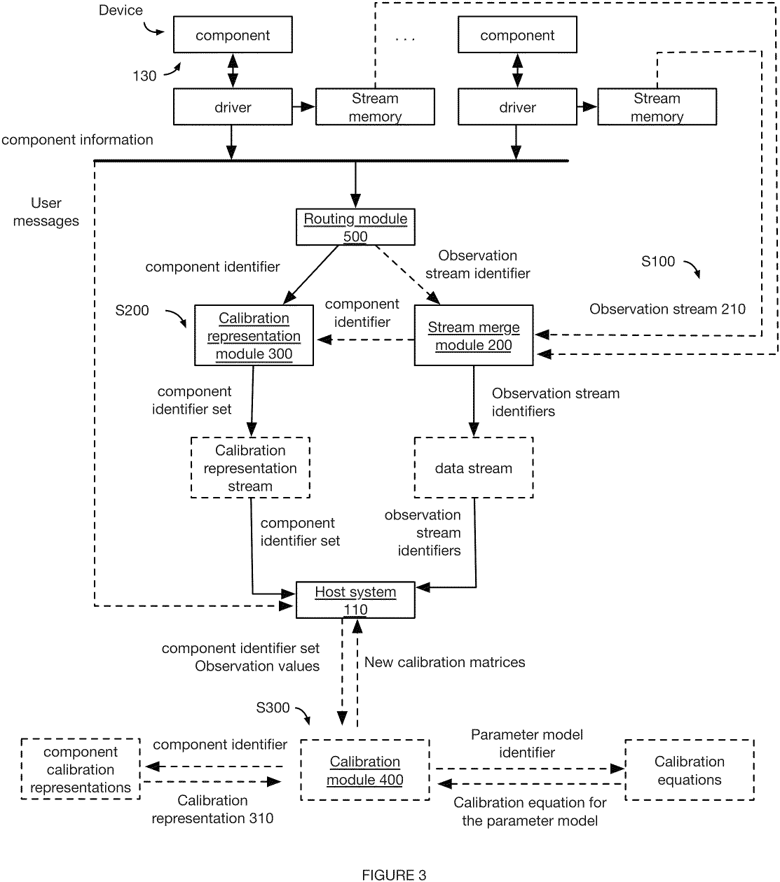

The calibration representation 310 (e.g., for a component, for the robot, etc.) can be obtained from: the device driver (e.g., example shown in FIG. 2), the component driver, the user (e.g., wherein the user is queried for the calibration representation after a new component connection to the host system is detected), a user account (e.g., storing previously-specified calibration representations, etc.), the platform (e.g., wherein the platform stores default calibration representations for each of a set of supported devices or components), the device or component manufacturer (e.g., via an API or other connection to the component manufacturer), a database associating the component identifier with a component representation (e.g., example shown in FIG. 3), and/or from any other suitable source. The calibration representation can be obtained by the system (e.g., the system specification module; the assembly module, example shown in FIG. 2; etc.), by the calibration module (e.g., example shown in FIG. 3), by the driver, by the host system, and/or by any other suitable element.

The same calibration representation 310 can be used for one or more instances of a given component, component type, device, device type, or robot. For example, a user can specify a single component calibration representation to be used for all cameras on the robot. In another example, a user can specify different component calibration representations for forward-facing cameras and rearward-facing cameras for a robot (e.g., collectively forming a robot calibration representation). In this example, the same forward-facing camera calibration representation and the same rearward-facing camera calibration representation can be used for all robots within the user’s robot fleet (e.g., the same forward-facing and rearward-facing calibration representations are used to calibrate all cameras labeled as “forward facing” and “rearward facing”, respectively). In variants, this can enable a user to create a single set of component calibration representations (e.g., robot calibration representation) for deployment across multiple robots, wherein a robot-specific calibration can be determined for each robot using the same component calibration representation set. Alternatively, different calibration representations can be determined for each individual component or device instance.

A calibration representation 310 can be defined for: a robot as a whole (e.g., robot calibration representation; system specification; etc.), an individual component (e.g., component calibration representation; component specification; etc.), an individual device (e.g., device calibration representations), and/or for any other suitable collection of components.

The robot calibration representation (calibration set specification, calibration set specification, robot Plex, system Plex, etc.) functions to provide the information needed to recalibrate a robot (e.g., the set of devices connected to a host system, inclusive of and/or exclusive of the host system itself). An example is shown in FIG. 10.

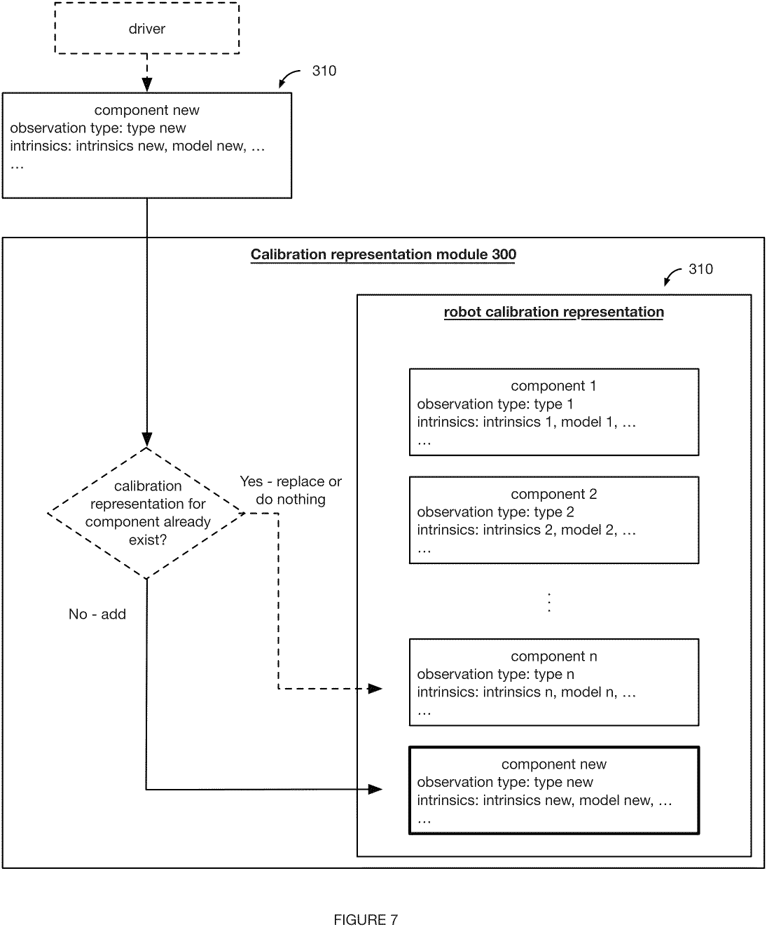

The robot calibration representation is preferably for the robot system (e.g., including the set of devices and optionally the host system), but can alternatively be for a subset of the devices, for a single device, for a single component, and/or for any other suitable set of entities. In a first variant, the robot calibration representation (e.g., “Plex”, system Plex, robot Plex, etc.) includes a set of component calibration representations (e.g., a set of files, a set of specifications, etc.), wherein the set of component calibration representations can include one or more component calibration representations for each component connected to the host system (e.g., within the robot); example shown in FIG. 7. In a second variant, the robot calibration representation is a unitary calibration representation (e.g., a single file, a single specification, etc.). In this variant, the robot calibration representation preferably has the same component information as the first variant (e.g., includes parameter model selections for each of component parameter for each component within the robot), but can additionally or alternatively include the final set of equations (e.g., for the system as a whole, for calibration), and/or include more or less information. However, the robot calibration representation can be otherwise configured. The robot calibration representation can be: retrieved (e.g., from host system memory, from platform memory, from an external database, from a driver, etc.), compiled (e.g., from the calibration representations for each of the set of components), manually specified, learned, and/or otherwise determined.

The component calibration representation (e.g., component calibration representation, component calibration specification, “sub-Plex”, “component Plex,” etc.) functions to provide the information needed to calibrate a single component (e.g., to determine the intrinsic and/or extrinsic parameter values for a component). An example is shown in FIG. 11. The component calibration representation can be: retrieved (e.g., from host system memory, from platform memory, from an external database, from a driver, from a manufacturer, etc.), manually specified, learned, and/or otherwise determined.

However, any other suitable set of calibration representations can be determined for a given robot.

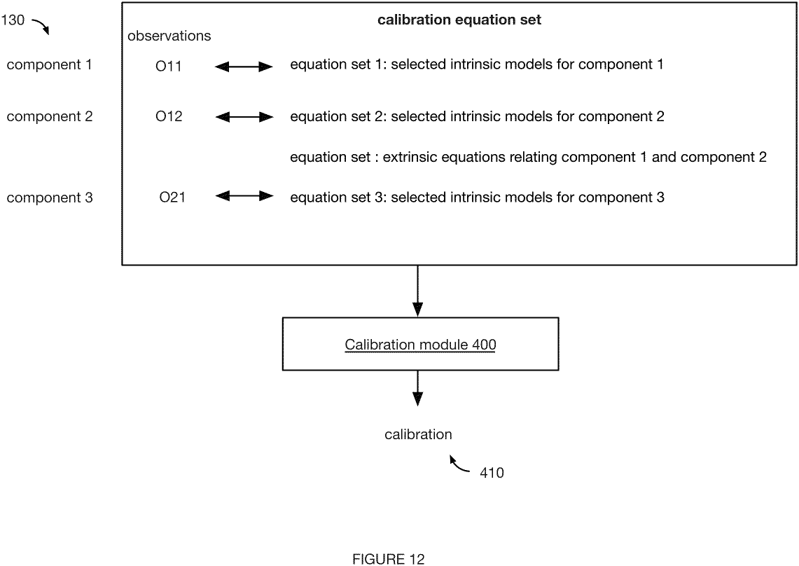

In operation, the calibration representation 310 can be used to determine (e.g., calculate) calibration parameter values (e.g., the intrinsics matrices for each component, the extrinsics matrices between component pairs, the calibration 410, etc.); examples shown in FIG. 11 and FIG. 12. For example, the models associated with each component (e.g., identified in each respective component calibration representation) can be aggregated into a set of equations (e.g., calibration set equation set; example shown in FIG. 12), optionally seeded with starting parameter values (e.g., specified values, estimated values, random values, etc.), populated with observation values from the respective components, and solved to obtain the calibration parameter values (e.g., using a bundle adjustment or other optimization method). The calibration parameter values (e.g., calibrated parameter values, calibration matrices, etc.) can be determined by: the component management system, the calibration module, and/or by another module. The calibration parameter values can be determined on: the host system (e.g., hosting the component management system), a cloud computing system (e.g., platform), a driver, a third party system, an endpoint, and/or by any other suitable computing system.

However, the calibration representations can be otherwise defined and/or used, and the calibration sets can be otherwise determined.

The component management system 10 can also be used with or include a platform, which functions as a centralized processing and/or storage system. The platform is preferably a remote computing system (e.g., cloud system), but can alternatively be an onsite system (e.g., collocated with the robot), be a distributed system, execute on the robot, and/or execute on any other suitable computing system. The platform can: store user accounts, store default calibration representations for a set of components, store user-specified calibration representations for a set of components, store calibration representations for robots (e.g., a history of calibration representations, user-defined calibration representations, etc.), store calibration sets, store component or device configurations, store robot access credentials, and/or store any other suitable information. In variants, the platform can execute the calibration module (e.g., retrieve component calibration representations, compile the calibration set equation set, determine the calibration sets, etc.). The platform can also enable robot fleet management (e.g., control the calibration representations for each of a set of robots within the fleet; determine and/or store the calibration sets for each of the set of robots, etc.), and/or enable other functionalities.

The component management system 10 can also be used with one or more endpoints that consume the calibration representation, the observation stream, the endpoint messages, and/or other information. Examples of endpoints that can be used include: clients, host systems (e.g., systems that the components are connected to, systems that interpret and/or act upon the observations, etc.), remote computing systems (e.g., cloud computing systems, platforms, etc.), user interfaces, and/or other endpoints. The endpoints can include user-defined logic defining how to use updated calibration representations, apply observations, and/or otherwise use the generated information.

The component management system 10 can include: an optional routing module 500; a calibration representation module 300; a stream merge module 200; a calibration module 400; and/or other elements. The component management system 10 functions to define the data connections and structures used to provide the host system with observations and/or calibration representations.

A new instance of the component management system 10 (and resultant data connections/structures) is preferably constructed each time the host system is rebooted, but can alternatively be constructed once (e.g., during initial host system setup), periodically, and/or at any other time. All or portions of the component management system can be executed on: the host system’s computing hardware, separate computing hardware, decentralized hardware (e.g., the device processors, etc.), a remote computing system (e.g., a cloud platform), and/or on any other suitable local and/or remote computing system. The component management system can be executed on: processing units (e.g., CPU, GPU, TPU, microprocessors, etc.), embedded systems, and/or other computing systems. The component management system is preferably a binary application, but can be any other suitable type of application.

Each module of the component management system (and submodules therein) preferably includes only atomic, non-blocking tasks (e.g., do not require context switch during execution, can execute fully without interruption, completes in a single step, failure or suspension of another task does not cause failure or suspension of another task, etc.); but can alternatively include one or more event-based tasks, blocking tasks, and/or be otherwise configured. The modules are preferably executed asynchronously (e.g., in any order), but can alternatively be executed in a predetermined order. One or more instances of each module preferably operate during host system operation (e.g., robot operation). Module execution preferably does not affect host system operation (e.g., the host system operation is not interrupted based on module initiation, execution, or completion); alternatively, host system operation can be interrupted and/or dependent on the execution state of one or more of the component management system’s modules.

The optional routing module 500 (e.g., “runtime configuration”) functions to route message information and/or determine device events (e.g., extract device events from the device messages, infer device events based on a set of rules, etc.). The routing module preferably receives messages from all drivers (e.g., all drivers are configured to route all or a subset of the message types to the routing module), but can alternatively receive messages from a subset of drivers (e.g., wherein the system can include multiple routing modules or some messages — such as user messages - can bypass the routing module). In an example, all drivers are configured (e.g., by the user, by the device manufacturer) to send driver messages to a predetermined endpoint (e.g., API endpoint, address, reserved name, etc.) associated with the routing module. However, the driver messages can be otherwise routed to the routing module. The routing module can be identified by a reserved name, such that all drivers will always send messages to the local routing module instance, but can be unidentified, be identified by a dynamically determined identifier (e.g., the identifier for a channel initialized during initial runtime execution), and/or otherwise identified. Additionally or alternatively, the routing module can receive: observation streams, component observations, calibration information, component state, and/or other information. One or more routing modules can be contemporaneously executed by a single host system, and can operate in separate and distinct contexts (e.g., process space) and generate their own futures, or operate in the same context.

The routing module 500 can further function to parse, interpret, or extract information from driver messages, and/or perform other functionalities. In a first example, the routing module can be configured to be compliant with the driver message formats for one or more drivers (e.g., from one or more manufacturers, etc.), wherein the routing module can optionally translate the driver message information into a platform-standard message format. In a second example, the routing module can be configured to interpret messages in the platform-standard format (e.g., only in the platform-standard format), wherein the driver messages all comply with the platform-standard format. In a third example, the routing module can be generic to all message formats, and apply a set of rules to parse and forward the relevant information from the message, which can push message information interpretation to downstream modules and/or endpoints. However, the routing module can be otherwise configured.

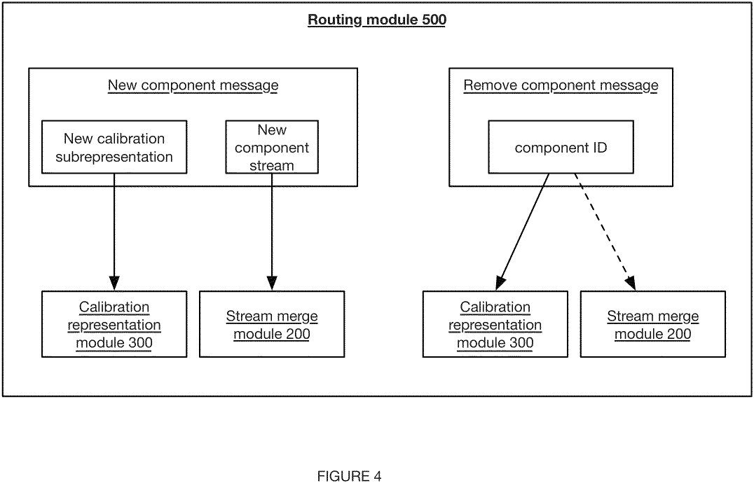

In a first variant, the routing module routes information based on the driver message type (example shown in FIG. 4). In this variant, the routing module can determine the driver message type, determine a set of module endpoints based on the driver message type, and route information from the driver message to the module endpoints. In a first example, the routing module receives a new component message including an observation stream and a component calibration representation, forwards the observation stream to the stream merge module, and forwards the component calibration representation to the calibration representation module. In a second example, the routing module receives a component message including an observation stream and a component identifier, forwards the component message (and/or just the observation stream and component identifier) to the stream merge module, and forwards the component identifier to the calibration representation module. In a third example, the routing module receives a “remove component” message and routes the component identifiers (for the disconnected components) to the calibration representation module. However, driver messages and/or information therein can be otherwise routed.

In a second variant, the routing module routes information based on the information’s datatype. For example, the routing module can route all observation streams or observations to the stream merge module, route all calibration representations to the calibration representation module, and route all user messages to the user interface.

In a third variant, the routing module can optionally route all user messages to the client or another designated endpoint.

However, the routing module can be otherwise configured.

The calibration representation module 300 (“assembly”, “Plex Assembly”, etc.; system specification module; etc.) functions to determine calibration representations 310. The calibration representations can be subsequently used to generate the calibration matrices, include the calibration matrices themselves, or be otherwise configured. The calibration representation module can additionally or alternatively determine whether all connected components are represented in the current calibration representation, identify which calibration representation to use, and/or perform other functionalities.

The calibration representation module 300 preferably determines a robot calibration representation (e.g., for all components connected to the host system; for all components streaming observations to the host system; for the components that the host system is using; etc.), but can alternatively determine a component calibration representation (e.g., for a newly-connected component, etc.) and/or determine a calibration representation for any other suitable collection of components. The calibration representations can include a component calibration representation for each component connected to the host system (example shown in FIG. 7), a set of constraints between the components (e.g., spatial constraint, temporal constraint, dependent relation, etc.), and/or other information needed to describe the components and relationships therebetween.

The calibration representation module 300 can indirectly determine the calibration representation 310 (e.g., facilitate calibration representation determination; determine the set of component identifiers for which calibration representations need to be determined; determine the set of component identifiers that the robot calibration representation needs to include calibration representations for; etc.), directly determine the calibration representations (e.g., compile the component calibration representations into the robot calibration representation, obtain the component calibration representations, etc.), and/or otherwise determine the calibration representation.

The calibration representation module 300 can determine a calibration representation 310: periodically, responsive to a component state change (e.g., component connection to the host system, component disconnection from the host system, component failure, etc.), responsive to a recalibration event, and/or at any other suitable time. The calibration representation module is preferably executed onboard the robot (e.g., by the host system, by a collocated processing system, by a device processor, etc.), but can alternatively be executed remote from the robot (e.g., by the platform, by a fleet management system, etc.).

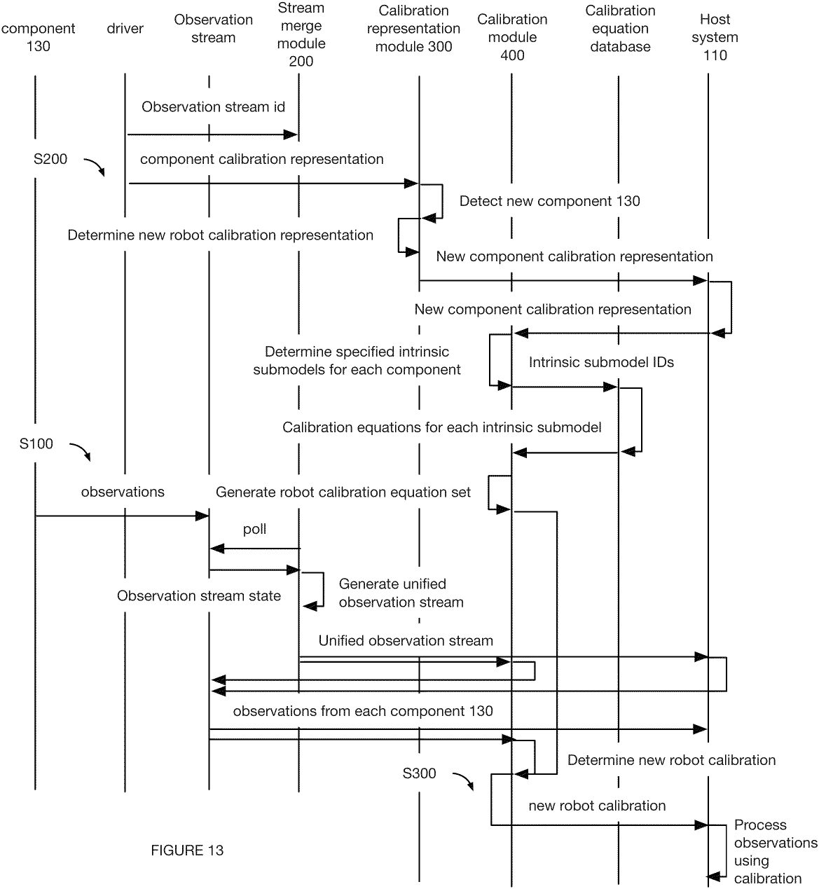

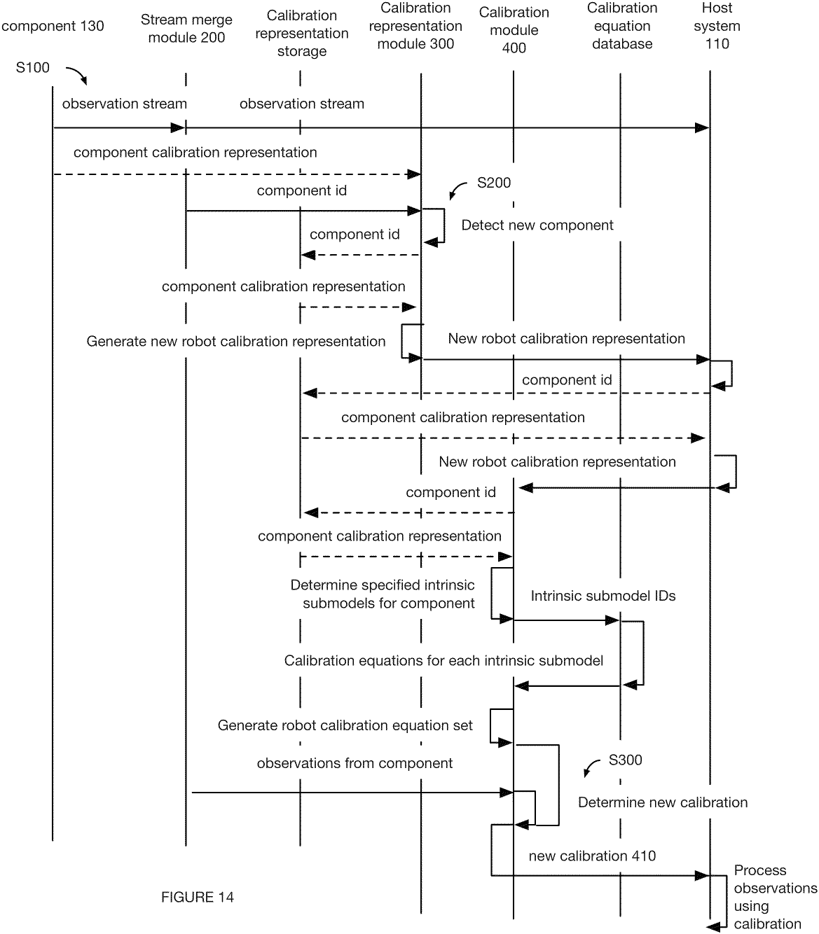

In a first variant, the calibration representation module 300 generates calibration representations 310, but does not generate the calibration matrices for the host system. The calibration representation module preferably generates the calibration representation by merging or removing component calibration representations (e.g., predefined component calibration representations) from the robot calibration representation, but can otherwise generate the calibration representation. The component calibration representations and/or identifier therefor can be received from the routing module, the driver (e.g., examples shown in FIG. 2 and FIG. 13), from a database (e.g., wherein the calibration representation module retrieves the respective calibration representations, etc.; example shown in FIG. 14), and/or from any other source. The determined calibration representations can be provided as part of (e.g., appended to) a calibration representation stream (e.g., “Plex stream”) or otherwise provided to other modules and/or endpoints. The calibration representation stream can be provided to the host system, the calibration module, and/or any other suitable endpoint.

In a first example, the calibration representation module 300 merges the new component calibration representation for a new component with the existing robot calibration representation. The “new” state of the component can be determined: by the routing module, by the driver, by the calibration representation module (e.g., when the component identifier does not match another component in the existing component listing or the existing calibration representation), or otherwise determined. The new component calibration representation can be received from the component’s driver (e.g., as part of a driver message), be retrieved based on the component identifier (e.g., determined from a driver message, from the component’s observation stream, etc.), and/or otherwise determined. In a first embodiment, the calibration representation module can add the new component’s component calibration representation (e.g., append, concatenate, or otherwise add the new component representation) to the calibration representation, and optionally define default constraints (e.g., spatial constraints, temporal constraints, etc.) between the new component and existing components (e.g., between the new component and a subset of the existing components, between the new component and all existing components, etc.). In a second embodiment, the calibration representation module appends the new component calibration representation to the existing calibration representation. However, the calibration representation module can otherwise handle new component calibration representations.

In a second example, the calibration representation module 300 removes the component calibration representation for a disconnected or failed component from the existing calibration representation. The disconnected state of the component can be determined by the respective driver, by the routing module, by the host system, by the streaming module (e.g., when observation streams have not been received from the component for a threshold period of time, when the observation streams from the component are corrupted, etc.), or otherwise determined. In this example, the calibration representation module preferably receives an identifier for the removed component, and removes the component calibration representation associated with the removed component’s identifier from the existing calibration representation. However, the calibration representation module can otherwise handle the component calibration representations for disconnected components.

In a third example, the calibration representation module 300 can replace the prior component calibration representation for a shifted component (e.g., a connected component that physically shifted relative to the host system). In a first embodiment, the calibration representation module receives a component calibration representation associated with a component identifier already within the calibration representation and overwrites the prior component calibration representation with the new component calibration representation. In a second embodiment, the calibration representation module removes the prior calibration representation (e.g., using the second example above), and adds the new calibration representation (e.g., using the first example above). Alternatively, the calibration representation module can do nothing when a shifted component is detected, wherein the robot can be recalibrated using the same (e.g., prior calibration representation). However, the calibration representation module can otherwise handle the component calibration representations for shifted components.

In a second variant, the calibration representation module 300 can compile a set of component identifiers for the robot, wherein the component identifiers are used by a downstream module (e.g., the calibration module) to determine the calibration representation 310 for the robot (e.g., examples shown in FIG. 3 and FIG. 14). For example, the downstream module can determine the calibration representation for the robot by retrieving the respective component calibration representations for the component identified in the set (e.g., all component calibration representations, only the new component calibration representations, etc.), by removing the component calibration representations for the components missing from the updated component identifier set, and/or otherwise using the component identifier set to determine the robot calibration representation. Alternatively, the calibration representation module can determine the change in the set of component identifiers, and communicate the change instead of the entire component identifier set. In this variant, the calibration representation module can neither determine the calibration representations themselves nor determine the calibration matrices. In variants of the system, this calibration representation module variant can reduce the amount of information that is transferred between different computing systems (e.g., the components, the host system, and the calibration module, etc.), which can create a more robust system, reduce the amount of on-board memory needed, enable centralized calibration representation storage (e.g., wherein the calibration representations can be retrieved from the same centralized store), enable more efficient computation, and/or provide other technical benefits.

In a third variant, the calibration representation module 300 generates updated calibration matrices. In this variant, the calibration representation module determines the calibration representation (e.g., using the first variant; by retrieving the calibration representation from storage based on the component identifier set determined using the second variant; etc.), determines the observations (e.g., from the stream merge module, from the unified data stream, etc.), and calculates the updated calibration matrices.

However, the calibration representation module can be otherwise configured.

The stream merge module 200 functions to merge the observation streams 210 associated with each component into a single, unified data stream. The stream merge module is preferably executed onboard the robot (e.g., by the host system, by a collocated processing system, by a device processor, etc.), but can alternatively be executed remote from the robot (e.g., by the platform, by a fleet management system, etc.).

The stream merge module 200 preferably stores the observation stream identifiers (e.g., pointers) for each component (e.g., in a collection, a queue, an array, etc.), but can additionally or alternatively store a set of observations output by one or more observation streams, store the observation streams themselves (e.g., concatenate the streams together), not store any information, or be otherwise configured. The stream merge module can store the information persistently (e.g., during host system operation, between host system operation instances, across different instances of the same observation stream, etc.), temporarily (e.g., remove the stream information once the observation stream packet is forwarded), and/or for any other suitable period of time. The observation stream identifiers can be received via driver messages (e.g., during startup, from a new component message, etc.), from the observation stream itself, be a component identifier, be automatically generated (e.g., wherein an observation stream object is automatically generated for each stream of observations output by a component), or otherwise determined.

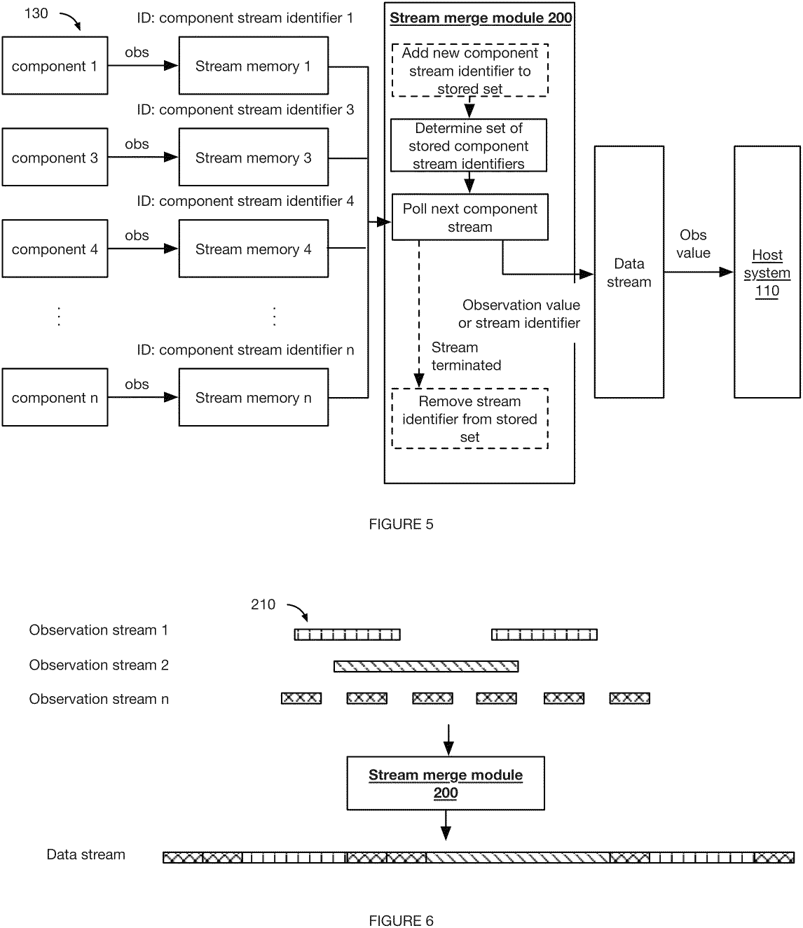

The stream merge module 200 can poll each observation stream 210 (e.g., using the observation stream identifier) for observation values, the stream state (e.g., whether the stream or memory space contains an observation value, whether an observation value is forthcoming, etc.), observation stream objects (e.g., including one or more observations), and/or for other information (example shown in FIG. 5). However, the stream merge module can request the observation streams from the components or otherwise obtain the observation stream information. The observation stream identifiers can be polled in parallel, in series, in a predetermined order, randomly, or otherwise polled. The observation stream identifiers can be polled continuously, at a predetermined frequency (e.g., the sampling frequency for the respective component, etc.), responsive to a polling event, and/or at any other time. The stream merge module can poll the observation streams using: roll call polling, hub polling, and/or other polling methods. In variants, because the observation stream trait is polymorphic (e.g., implemented across multiple different object types), the same code can be used to poll different observation stream identifiers, each identifying different object types. This can reduce or eliminate the need to halt host system operation to set up new polling and merging logic for each new component. However, the observation stream trait can be otherwise configured, and/or the host system operation can be paused to add the new component’s observation polling logic.

The stream merge module 200 can merge the observation values returned by multiple observation streams into a unified data stream (e.g., unified observation stream) (e.g., example shown in FIG. 2), merge the identifiers for observation stream with changed states into the unified data stream (e.g., example shown in FIG. 3), or otherwise create the data stream. The data stream preferably functions as an interface between the observation streams (and/or the component memory spaces) and a downstream module (e.g., data handler, host system, etc.), but can alternatively be a data object used by the downstream module or be otherwise configured. The data stream is preferably an asynchronous channel fed by the observation streams or the stream merge module, but can additionally or alternatively be a data object (e.g., queue, ring-buffer, array, etc.), a time series of observations (e.g., from multiple components, of different component types, etc.), and/or any other suitable data structure. The data stream can pass through values to a downstream module, or store (e.g., aggregate) values. The data stream can manage (e.g., pass through or manage): observation stream identifiers (e.g., pointers), observation values (e.g., retrieved from the referenced component memory spaces), and/or any other information. When the data stream includes observation values, the merged observation values can have different object types or be wrapped in a standard object type (e.g., an observation stream object type, etc.). The observation streams and/or observation values within the data stream are preferably ordered based on the polling order, but can alternatively be ordered by sampling time and/or otherwise ordered.

Each instance of the system 10 preferably includes a single data stream (e.g., initialized during startup), but can alternatively include multiple data streams, multiple data stream instances (e.g., wherein a new data stream instance is generated each time a observation stream is added or removed), and/or any other number of data streams or instances thereof. Downstream modules can subscribe to the data stream, poll values from the data stream, pull values from the data stream, poll values from memory spaces identified by the data stream, and/or otherwise obtain observation values from the data stream.

In a first variant, when an observation value is returned, the stream merge module can pass the returned observation value to the downstream client via the data stream (e.g., examples shown in FIG. 2 and FIG. 5).

In a second variant, the stream merge module can pass the observation stream identifier to the data stream (e.g., examples shown in FIG. 3 and FIG. 5), wherein the data stream can: retrieve the observation value (e.g., from the observation stream, from the observation stream or component’s reserved memory, etc.) and pass the retrieved observation value to the downstream module; pass the observation stream identifier to the downstream module, which then retrieves the observation value from the referenced memory space; and/or otherwise handle the observation stream identifier.

In a third variant, the stream merge module can append the returned observation value to the prior data stream (e.g., using round-robin logic, FIFO, and/or other merging logic), example shown in FIG. 6.

However, the stream merge module can otherwise manage returned observation values.

The observation streams 210 can optionally return termination values (e.g., indicative of stream termination, component disconnection, component unavailability, etc.), pending values (e.g., indicating that the next value is not ready yet), and/or any other values. For example, when an observation stream returns a value indicative of stream termination (e.g., “Poll::Ready(None)”), the stream merge module can: remove the observation stream identifier from the stored set of observation stream identifiers (example shown in FIG. 5), cease polling the observation stream identifier, leave the observation streams from disconnected components intact (e.g., not remove them from the unified data stream, since the lack of data on said stream will not impact system performance), notify the calibration representation module (e.g., instruct the calibration representation module to remove the calibration representation for the component associated with the observation stream identifier), and/or otherwise manage the terminated stream.

However, the stream merge module can merge observation streams in any other manner.

The calibration module 400 functions to generate calibration set 410 (e.g., a set of calibration matrices for the robot, for the host system, for the set of devices, etc.) based on the calibration representation(s) and observations (e.g., using an optimization). The calibration module can be executed onboard the robot (e.g., by the host system, by a collocated processing system, by a device processor, etc.), be executed remote from the robot (e.g., by the platform, by a fleet management system, etc.), and/or be otherwise located relative to the host system. The calibration module is preferably centralized and used to determine the calibrations for multiple robots, but can alternatively be distributed, be specific (e.g., local) to a robot, and/or be otherwise configured.

The calibration module 400 can generate a new calibration set 410: when an updated calibration representation is available, when an updated component identifier set is available, responsive to a calibration event (e.g., calibration request, robot error exceeding a threshold, etc.), and/or at any other suitable time. In an example, the system outputs (e.g., observations and calibration representations) can be serialized and used as inputs for calibration at a later time. The calibration module can determine the new calibration set: in real time (e.g., as new calibration representations are generated), asynchronously (e.g., after a trigger event occurs, such as a host system calling the calibration module), and/or at any other suitable time.

The calibration module 400 can determine a calibration set 410 for each: component identifier set, calibration representation, and/or other set of data objects. The calibration module can receive: a component identifier set for the robot, a robot calibration representation, a single component identifier (e.g., for the added or removed component), a single calibration representation (e.g., for the added or removed component), and/or any other information. In a first example, the calibration module can determine a calibration set for each new calibration representation (e.g., each new robot calibration representation). In a second example, the calibration module can determine a calibration set for each combination of component identifiers within the component identifier set (e.g., a first calibration set for all components within the set; a second calibration set for a subset of the components; a third calibration set for a different subset of components; etc.). In variants, this example can enable the host system to gracefully fall back on an already-determined calibration set when a component fails, wherein the host system can simply use the calibration set associated with the currently-running set of components. In a third example, the calibration module can determine calibration matrices for only the new components (e.g., for new component calibration representations, for new component identifiers, etc.), wherein the calibration module can use the prior calibration matrices and/or calibration representation to determine the new component calibration matrices.

The determined calibration set 410 can be identified by: the calibration representation used to determine the calibration set, the component identifier set (e.g., for the set of calibrated components), a timestamp (e.g., the calibration time, the calibration representation determination time, etc.), a randomly-generated identifier, and/or otherwise identified. The calibration set can include the intrinsic matrices and extrinsic matrices (e.g., with values and covariances; individual matrices or within a single large matrix) for all components connected to the robot and/or represented within the robot calibration representation. The determined calibration set can be sent to the host robot for use, stored in association with a robot identifier (e.g., wherein the platform can store a history of calibration sets and/or robot calibration representations), and/or otherwise managed.

The calibration module 400 can determine the calibration set 410 based on one or more calibration representations 310. In a first variant, the calibration module can receive the robot calibration representation, wherein the robot calibration representation is compiled (e.g., from constituent component calibration representations) by the calibration representation module. In a second variant, the calibration module can compile the robot calibration representation. In this variant, the calibration module can receive a set of component identifiers (e.g., globally unique component identifiers, component identifiers that are locally unique but shared for the same component across different robots, etc.), retrieve the calibration representations for the respective components (e.g., from a database, from a user, etc.), and compile the component calibration representations into a robot calibration representation. However, the calibration module can otherwise determine the calibration representation.

The calibration module 400 can determine the calibration set 410 by: determining the calibration equations based on the calibration representation; determining observations from each component (e.g., received from the stream merge module, from the host system, from the component itself, etc.; wherein the observations can be saved by the host system and sent to the calibration module or streamed directly to the calibration module); and calculating the calibration set (e.g., calibration matrix(es)) using the calibration equations, the observations, and optionally a set of constraints (e.g., defined by the calibration representations, default constraints, etc.). The calibration equations can be: retrieved (e.g., from a calibration equation database) based on the parameter models identified for each component parameter for each component (e.g., wherein each parameter model is associated with its own set of calibration equations) and compiled into a calibration equation set (e.g., calibration set equation set); obtained directly from the calibration representation; a modified set of prior calibration equations (e.g., wherein calibration equations associated with added or removed components are added or removed from the set), and/or otherwise determined. In an example, the calibration module constructs a set of calibration equations by retrieving the equations associated with the intrinsic submodels identified in each individual component calibration representation and a set of extrinsic equations. The calibration set can be determined using an optimization (e.g., bundle adjustment, etc.) and/or other calibration method. However, the calibration module can determine the calibration set in any other suitable manner.

The calibration module 400 preferably executes concurrently with robot operation (e.g., enables online calibration), and can generate the new calibration set without interrupting robot operation. Alternatively, robot operation can be paused while the new calibration is being determined. In a first example, when a new component is connected, the robot can operate using the previous calibration matrix determined based on the prior calibration representation (e.g., without the new component’s calibration representation) and ignore observations from the new component until a new calibration matrix (generated using the component calibration representation for the new component) is available. In a second example, when a component is disconnected, the robot can operate using the previous calibration matrix based on the prior calibration representation (e.g., with the calibration representation for the disconnected component).

In variants, the component management system 10 can be used with or include a user interface, which functions to enable the user to interact with the devices, components, host system, platform, and/or other entity. The user interface can be a browser, an application (e.g., smartphone application, native application, etc.), an API, a CLI, and/or other interface. The user interface can be accessible via the host system, the platform, and/or other computing system. The user interface can enable the user to interact with the observation stream, the drivers, and/or with any other suitable object via the device specific library or API, via a unified library or API (e.g., wherein the unified API calls are translated to device-specific API using a translation layer or module, or the driver APIs are compliant with the unified API), and/or via other protocols (e.g., which can be installed on the host system, platform, devices, components, and/or other elements). For example, the user interface can enable the user to configure the device or components (e.g., specify device or component configuration values), enter device or component instructions (e.g., start stream, restart stream, pause stream, interrupt stream, etc.), and/or provide other device or component commands, which are then sent to the respective driver. The user interface can also enable the user to control robot operation, such as enable the user to enter system configurations, system commands (e.g., start or stop robot operation, start or start the component management system, recalibrate, etc.), and/or other instructions, which can be sent to the host system or another endpoint for execution. The user interface can also present device events, emitted by the device drivers, to the user. However, the user interface can be otherwise used or configured.

The component management system 10 can optionally be used with a set of serialization modules, which can function to convert data objects into sequences of bits (e.g., serialization format) and specify how to read and interpret bytes from the data (e.g., deserialize the information). The component management system is preferably compatible with any serialization method and format, but can alternatively be specific to a specific serialization method and format. The serialization method and formats are preferably selected by the user (e.g., from a set of serializer options; be independent from the message transport protocol), but can alternatively be specified by the message transport method, by the host system, by a device’s driver, and/or otherwise determined. The robot preferably uses a single serialization method and/or format, but can alternatively use multiple different serialization methods and/or formats. In an example, each module of the component management system (and optionally the drivers) can include a deserializer and serializer for the selected serialization method and/or format. Alternatively, each driver can include the selected serializer and the host system can include the respective deserializer, wherein the component management system modules can be agnostic to serialization format. However, any other suitable object used with the component management system can include the selected serializers and/or deserializers. Examples of supported serialization methods and/or formats can include: protobuf, YAML, JSON, and/or other serialization methods and/or formats.

The component management system 10 can optionally be used with a set of message transport protocols, topologies, and/or paradigms, which can function to transport data from a source to a destination (e.g., from a process thread to another, from a machine to another machine, etc.). The component management system is preferably compatible with any message transport protocol, topology, and/or paradigm, but can alternatively be specific to a specific message transport protocol, topology, and/or paradigm. The message transport protocol, topology, and/or paradigm is preferably selected by the user (e.g., from a set of message transport options), but can alternatively be specified by the host system, by a device’s driver, by a user-selected library, and/or otherwise determined. The robot preferably uses a single message transport protocol for all components, but can alternatively use different message transport protocols for different components. Examples of supported message transport protocols can include: TCP, UDP, webRTC, RTP, and/or other communication protocols. Examples of topologies that can be supported include: mesh, mixing, routing, publication-subscription, request-based, and/or other topologies.

In variants, the system can optionally include a runtime context, wherein the runtime context includes the drivers, handlers, and/or other tasks. The tasks within the runtime context are preferably added as an asynchronous task when the runtime context is executed, but can be otherwise added. The tasks within the runtime context can be: provided by the platform, provided by a manufacturer, written by a user, and/or otherwise defined. Examples of handlers can include: calibration representation handler, data stream handler, and/or other handler. The handlers can be configured to process, route, or otherwise manipulate the configuration representation, data stream, and/or other data.

However, the system can include or interface with any other set of systems or modules.

### 4 Method

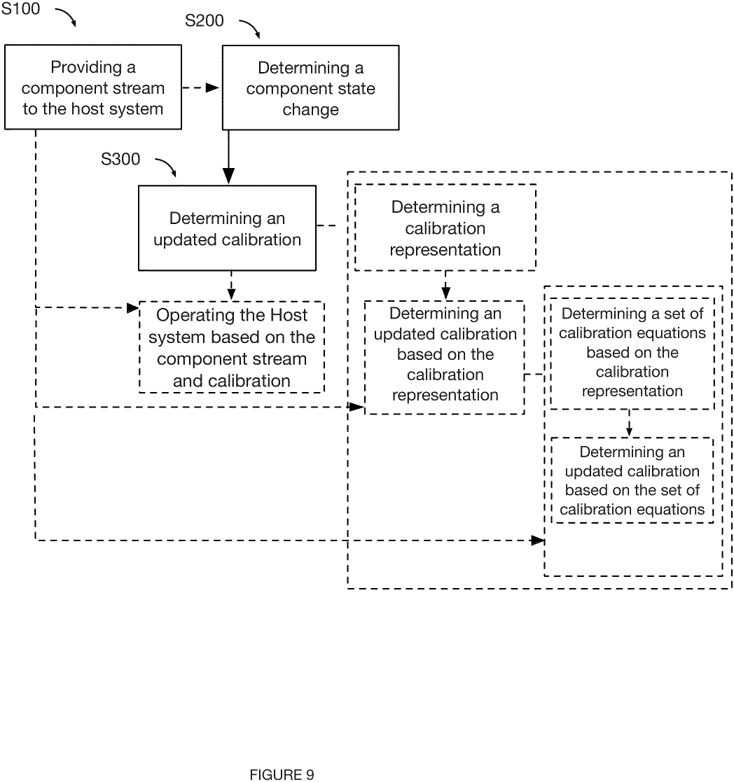

In variants, the method can include: providing a component stream to a host system S100; determining a component state change S200; and determining an updated calibration S300 responsive to the component state change (e.g., example shown in FIG. 9). The method functions to provide sensor streams to the host system in a modular, atomic, and non-blocking manner (e.g., which can enable plug-and-play capabilities), and can function to enable online calibration in a scalable manner.

The method can be performed using the system described above, or be performed using any other suitable system. The method can be performed during robot operation (e.g., concurrently, contemporaneously, etc.), but can alternatively be performed before or after robot operation.

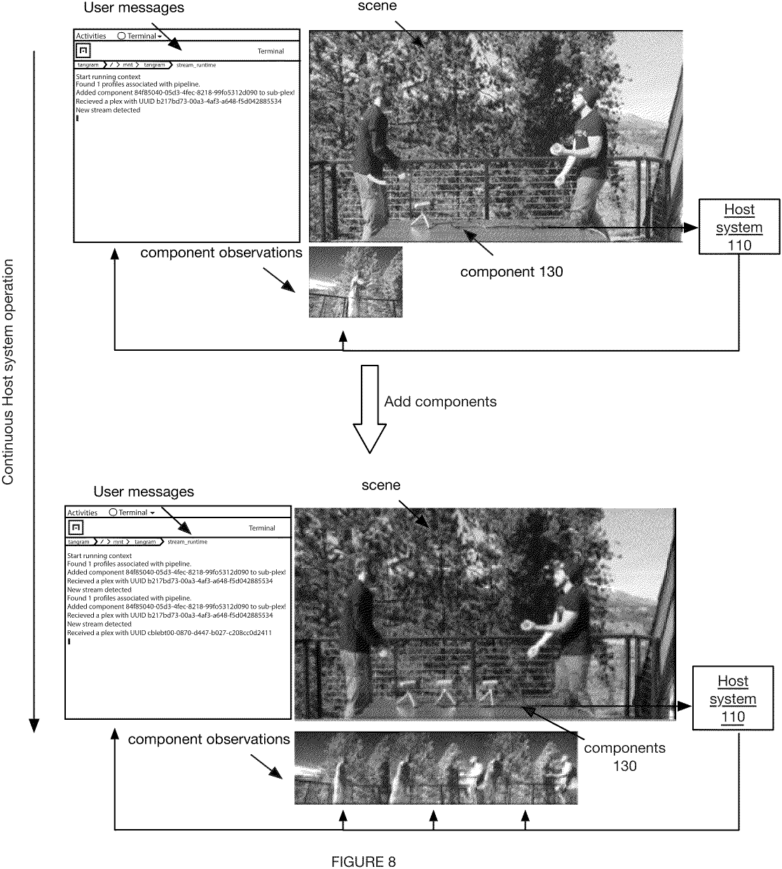

Different variants of the processes discussed above can be used when: connecting a new component; managing observations output by the new component; managing component disconnection; managing component reconnection; and/or other methods. All of the above processes are preferably performed during host system operation (e.g., operation using other, already-connected components; example shown in FIG. 8), but can alternatively be performed while the host system is not operating or is paused. One or more instances of the method can be performed one or more times for one or more components. The method can be performed by a collocated computing system (e.g., the host system) or by a distributed system (e.g., the host system and a platform, etc.). All or a portion of the method processes can be atomic, non-blocking, and/or execute asynchronously.

Data sent between different machines, threads, memory spaces, processes, modules, and/or other computing elements are preferably serialized and/or deserialized using a serializer selected by the user, but can be serialized and/or deserialized using a platform-standard serializer, and/or using any other suitable serializer. Data sent between different machines, threads, memory spaces, processes, and/or other computing elements are preferably transmitted using a user-selected message transport protocol, but can alternatively be transmitted using any other suitable message transport protocol.

Providing a component stream to a host system S100 functions to provide the observation stream, generated by a component, to the host system. The observation stream is preferably provided in real- or near-real time with observation generation, but can alternatively be provided asynchronously (e.g., after a delay). Observation streams from one or more components can be provided to the host system (e.g., concurrently, sequentially, asynchronously, etc.). The observation stream can be provided during host system operation or afterward. In a first variant, the observation stream is provided by the component to the stream merge module, the host system, or another endpoint. In a second variant, the observation stream is provided by the stream merge module to the host system. In a third variant, the observation stream is retrieved by the host system (e.g., based on a series of observation stream identifiers determined by the stream merge module and sent to the host system). However, the observation stream can be otherwise provided.

In variants, providing the component stream S100 can include: optionally initializing an observation stream object (e.g., with the component’s driver; by generating a new observation stream event, wherein the event is routed to the stream merge module by the routing module, etc.); optionally registering observation stream object with the stream merge module; and storing the observations from a component within an observation stream (e.g., within an observation stream object). The stream merge module can optionally poll the observation stream object (e.g., for a state change), and include the observation stream object identifier, the observation stream, or the new observations from the stream within a unified observation stream, wherein the unified observation stream is provided to the host system, calibration module, or other endpoint. When the unified observation stream does not include the observations themselves, the endpoint can query the observation stream object or memory to obtain the observations themselves.

In variants, providing the observation stream S100 can include, during host system operation: with a driver, generating a driver message including device information based on the associated component’s state; receiving the driver message at a routing module; selectively routing device information (and/or subsets thereof) to different processing modules based on the component state; and reconfiguring a stream object based on the device information. The reconfigured stream object(s) is then used by the host system to manage observations output by the component. In variants, the driver message can additionally or alternatively include calibration representations for the component, which can be used to determine the component state change and/or determine the updated calibration set.

Generating a driver message functions to inform the overall system of changes in a component’s state. The driver message is preferably generated by the driver managing the component, but can be generated by another module. Examples of driver messages can include: component addition (e.g., connection), component removal, component change, and/or other messages. component addition messages can be generated when the respective component is connected to the system (e.g., physically connected to the host system, powered, registered, etc.), and can include: a component calibration representation for the component (e.g., stored by the driver), a observation stream identifier (e.g., identifying a memory space allocated by the driver for observation values), a component identifier, and/or other information. component removal messages can be generated (or not generated) when the respective component is disconnected from the system or unavailable, and can include: a component identifier (and/or component calibration representation identifier), and optionally include an observation stream identifier. Component removal messages can be generated when the respective component changes physical state (e.g., pose), and can include: a component identifier, the component calibration representation, and/or other information. The driver messages can be sent to the routing module, a host system endpoint, and/or any other endpoint.

Selectively routing device information (and/or subsets thereof) to different processing modules based on the component state functions to direct information as needed to different processing modules, such that downstream processes can be performed atomically. The device information is preferably routed by the routing module, but can be automatically determined by the processing modules themselves (e.g., wherein the processing modules subscribe to a common communication bus for messages addressed to them) and/or otherwise determined. In variants, component calibration representations, component state, and/or component identifiers can be routed to the calibration representation module, and observation stream identifiers can be routed to the stream merge module. In a first example, for a new component message, component calibration representations and component identifiers can be routed to the calibration representation module and the observation stream identifier can be routed to the stream merge module. In a second example, for a changed component message and/or a removed component message, component identifiers and optionally the component calibration representations can be routed to the calibration representation module; no information is routed to the stream merge module. However, device information can be otherwise routed.

Reconfiguring the stream object(s) function to account for the changed component state (e.g., in the calibration set and in the observation streams). The stream objects are preferably reconfigured by the respective processing system (e.g., calibration representation module, stream merge module), but can be reconfigured by any other system.

In a first variant, reconfiguring the stream objects can include generating a unified observation stream (e.g., using the stream merge module). In this variant, the stream merge module can add new observation stream identifiers to the set of monitored observation streams, and immediately begin polling the new observation stream (e.g., stored in the memory space identified by the observation stream identifier) observation stream state changes (e.g., new observations added to the observation stream, etc.) and/or for observation values. In a first embodiment, generating the unified observation stream can include: polling the component observation streams for state changes, and adding the identifiers for the component observation streams with state changes to a unified observation stream object. The unified observation stream object can be accessed (e.g., provided) to the host system or other endpoint, wherein the endpoint can obtain the observation values from each observation stream based on the identifiers in the unified observation stream. In a second embodiment, each observation stream can return observation values, which can be passed to a data stream (e.g., the “reconfigured” stream object), wherein the host system or other downstream module (e.g., data handler) can receive the observation values through the data stream. In an illustrative example, this can be accomplished using a call on a future trait (e.g., “datastream.next().await”) wherein the chain of execution (e.g., coroutine, task, subroutine, future, etc.) is released to another task and/or the thread is released to another process when the data stream returns “Pending”. This polling can be repeated for all observation stream identifiers stored by or otherwise known to the stream merge module until an adverse event occurs (e.g., receipt of a component removal message, receipt of a stream termination value from the stream, etc.).

Alternatively, the stream merge module can remove an observation stream identifier from the set of monitored observation streams (e.g., when the driver message indicates that the observation stream should be removed).

Alternatively, the stream merge module can automatically remove an observation stream when the returned value indicates that the stream has terminated.

However, the stream merge module can otherwise handle the routed device information.

In a second variant, the reconfiguring the stream objects can include updating a calibration representation stream for the robot. In this variant, the calibration representation stream can include a time-series of: component identifier sets, component calibration representation sets, and/or a stream of any other suitable set of calibration representations. The calibration representation stream is preferably managed by the calibration representation module, but can be otherwise managed. In examples, the calibration representation module can receive the component calibration representation and/or component identifier, optionally remove existing component calibration representations associated with removed or changed components from the calibration representation for the system (e.g., by deleting the component’s calibration parameters from the calibration representation), and optionally add component calibration representations associated with added or changed component states to the calibration representation for the system. The updated calibration representation can be provided to the host system (e.g., via a calibration representation channel, the “reconfigured” stream object). The host system can determine (e.g., locally or using a remote system) an updated set of calibration matrices (e.g., extrinsics, intrinsics, covariances, etc.) based on the updated calibration representation and observations from the connected components and use the updated calibration matrices to interpret the observation values from the connected components; ignore observations from the removed or changed component; and/or otherwise respond to the updated calibration representation. However, the calibration representation module can otherwise handle the routed device information.

However, the observation streams (and/or other data) can be otherwise provided to the host system.

Determining a component state change S200 functions to determine when the calibration set should be updated. The component state change can be determined by the component driver, by the stream merge module, by the calibration representation module, by the host system, by the calibration module, and/or by any other suitable system. The robot preferably remains operable throughout the component state change (e.g., does not pause or fail with component addition, removal, or failure), but can alternatively pause or fail upon component state change. In examples, continuous robot operation throughout the duration of the component state change can be enabled by representing component state changes as asynchronous, non-blocking tasks within the system, and/or be otherwise accomplished.

In a first variant, the component state change is determined when a driver-emitted state change event, identifying the component, is received.

In a second variant, the component state change is determined when a new observation stream is detected (e.g., by the stream merge module), when a new component identifier is detected, or when a new component calibration representation is detected (e.g., by the calibration representation module). The new component identifier can be detected by the calibration representation module or other system, wherein the component identifier can be sent to the calibration representation module by the device driver, by the routing module, by the stream merge module (e.g., wherein the stream merge module can extract the component identifier from the observation stream(s)), and/or by any other suitable system. An observation stream, component identifier, and/or component calibration representation can be considered “new” when the observation stream, component identifier, and/or component calibration representation are not within the current (e.g., prior) set of observation streams, component identifiers, and/or component calibration representations, respectively; when the driver message identifies the observation stream, component identifier, and/or component calibration representation as new; and/or otherwise determined. For example, the component management system can continuously evaluate whether a component generating an observation stream is represented with a current calibration representation, and trigger updated calibration determination when the component is not represented within the current calibration representation.

In a third variant, the component state change is determined based on a set of rules, heuristics, and/or models (e.g., machine learning models, such as neural networks, etc.). For example, a component can be considered failed or missing when observations have not been generated within a predetermined time period or according to a predetermined sampling schedule, when the observations deviate beyond a threshold amount from previously sampled observations, and/or when the observations satisfy or fail any other suitable set of rules or conditions. In another example, a component can be considered physically shifted when a threshold robot acceleration, device acceleration, or acceleration difference between the component’s device and another device exceeds a threshold.

In a fourth variant, the component state change can be determined by the host system. For example, the host system can determine the component state change when the observation error exceeds a threshold, when the error of a downstream calculation using the set of observations exceeds a threshold (e.g., the SLAM error exceeds a threshold), and/or otherwise determined.

However, the component state change can be otherwise determined.

Determining an updated calibration S300 functions to determine an updated set of calibration matrices for the robot. The updated calibration is preferably determined responsive to the component state change (e.g., added component, removed component, shifted component, etc.), but can be determined periodically, responsive to a user request, and/or at any other suitable time.

In a first variant, determining the updated calibration S300 can include: determining a calibration representation for the robot; determining an updated calibration based on the calibration representation; and providing the updated calibration to the host system, wherein the host system processes subsequent observation streams from the components using the updated calibration.

Determining a calibration representation for the robot functions to determine the information needed to calibrate the robot. This can be performed by the calibration representation module, by the host system, by the calibration module, by a remote computing system (e.g., the platform), and/or by any other suitable system. The calibration representation preferably includes a calibration representation for each component that is currently connected to the robot (e.g., includes a calibration representation for the new component newly connected to the host system; excludes a calibration representation for the prior component that was disconnected from the host system; etc.), but can alternatively include calibration representations for more or less components. In a first variant, this includes obtaining the most recent calibration representation (e.g., “Plex”) from the calibration representation stream. In this variant, the component calibration representations can be compiled by the calibration representation module, wherein the calibration representation module can receive the component calibration representations from the respective drivers (e.g., example shown in FIG. 13), the respective manufacturers, from robot memory, and/or from any other suitable source. In a second variant, this includes determining the set of component identifiers (e.g., from the calibration representation stream), and retrieving the component calibration representations for each of the component identifiers from storage (e.g., platform storage, robot memory, the respective manufacturers, etc.), wherein the component calibration representations can be retrieved based on the component identifiers by the calibration module, the host system, or by another system (e.g., example shown in FIG. 14). In a third variant, this includes retrieving a precompiled (e.g., previously aggregated) robot calibration representation. However, the calibration representation can be otherwise determined.

Determining an updated calibration based on the calibration representation functions to determine the new calibration for the new set of components. In a first variant, this can include: retrieving the calibration equations associated with each parameter model (e.g., intrinsic submodel) for each component parameter (e.g., intrinsic parameter) identified in each component calibration representation; compiling the calibration equations into a calibration set equation set; obtaining observations from the components; and determining the updated calibration based on the observations and the calibration set equation set (e.g., using a bundle adjustment) (e.g., examples shown in FIG. 11, FIG. 12, FIG. 13, and FIG. 14). In a second variant, this can include: adjusting a previously determined calibration set equation set based on the component state changes (e.g., adding calibration equations for added components; removing the calibration equations for removed components; etc.); obtaining observations from the components; and determining the updated calibration based on the modified calibration set equation set. The observations can be streamed directly (e.g., from the stream merge module, from the component, etc.), be sent by the host system, be retrieved from memory (e.g., be historical observations), and/or otherwise obtained.

Providing the updated calibration to the host system can include: sending the updated calibration from the calibration system to the host system (e.g., as an update, in a calibration stream, etc.); storing the updated calibration (e.g., in association with an identifier for the component set, such as a calibration representation identifier, etc.) in storage accessible by the host system, wherein the host system can retrieve the updated calibration; and/or otherwise providing the updated calibration to the host system. The host system can process subsequent observation streams from the components using the updated calibration, and/or otherwise use the calibration.

In a second variant, determining the updated calibration includes retrieving a predetermined calibration set for the current set of connected components.

However, the updated calibration can be otherwise determined.

All references cited herein are incorporated by reference in their entirety, except to the extent that the incorporated material is inconsistent with the express disclosure herein, in which case the language in this disclosure controls.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously, concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A method, comprising:
• providing a set of component streams, each generated by a component of a set of components connected to a robot, to a host system of the robot;
• determining a component state change within the set of components; and
• responsive to the component state change:
• determining a calibration specification for each component of the set of components;
• determining an updated calibration for the robot based on the set of calibration specifications; and
• providing the updated calibration to the host system, wherein the host system processes subsequent component streams from the set of components using the updated calibration.

2. The method of claim 1, wherein the updated calibration is determined contemporaneously with robot operation.

3. The method of claim 1, wherein the calibration specification for each component identifies an intrinsic submodel from a set of candidate intrinsic submodels for the respective component, wherein the identified intrinsic submodel is used to determine intrinsic calibration equations for the respective component, wherein the intrinsic calibration equations are included in a calibration set equation set used to determine the updated calibration.

4. The method of claim 1, wherein the component state change comprises an added component, wherein the updated calibration is determined based on a calibration specification for the added component.

5. The method of claim 1, wherein each calibration specification is received from a driver for the respective component.

6. The method of claim 1, wherein the set of component streams is provided to the host system using a serializer and a message transport protocol, wherein the serializer and the message transport protocol are selected from a set of supported serializers and message transport protocols, respectively.

7. The method of claim 1, wherein the set of component streams are merged into a unified stream, wherein providing the component stream to the host system comprises sending the unified stream to the host system.

8. The method of claim 1, wherein the host system interacts with observations within a component stream of the set of component streams using an API specific to the respective component.

9. The method of claim 1, wherein providing the set of component streams, determining the component state change, and determining the updated calibration are processes that are atomic, execute asynchronously, and are non-blocking.

10. The method of claim 1, wherein each component comprises a sensor package.

11. The method of claim 1, further comprising a user interface, configured to:
• present device events emitted by drivers of the set of components to a user; and
• receive user-specified stream configurations that are sent to a driver for a component of the set of components.

12. A system for robot data stream management, comprising:
• a stream merge module configured to merge a set of component data streams, each generated by a different component connected to a robot, into a unified stream;
• a system specification module, configured to determine a set of calibration specifications for a set of components connected to the robot; and
• a calibration module, configured to determine an updated calibration based on the set of calibration specifications, wherein a host system of the robot processes subsequent component streams from the set of connected components using the updated calibration.

13. The system of claim 12, further comprising a user interface, configured to:
• present device events emitted by a driver for a component of the set of components to a user; and
• receive user-specified stream configurations that are sent to a driver for a component of the set of components.

14. The system of claim 12, further comprising:
• a serializer selected from a set of serializers and configured to serialize the component data streams; and
• a message transport protocol selected from a set of message transport protocols and configured to transport the serialized component data streams from the components to the host system of the robot;
wherein the serializer and message transport protocol are not mutually dependent.

15. The system of claim 12, wherein each calibration specification identifies an intrinsic submodel for each of a set of intrinsic parameters for the respective component, wherein each intrinsic submodel is selected from a set of candidate intrinsic submodels for the respective intrinsic parameter.

16. The system of claim 15, wherein the calibration module uses equations associated with the identified intrinsic submodels when determining the updated calibration.

17. The system of claim 12, wherein the component comprises a sensor package.

18. The system of claim 12, wherein the stream merge module comprises a stream polling module.

19. The system of claim 12, wherein the calibration module is remote from the stream merge module, the system specification module, and the host system.

20. The system of claim 12, wherein the stream merge module, the system specification module, and the calibration module are atomic processes and execute asynchronously.
